(19) United States
(12) Patent Application Publication
(10) Pub. No.: US 2026/0139985 A1
(43) Pub. Date: May 21, 2026

(54) TEMPERATURE-NORMALIZED FILLING VOLUME DETERMINATION IN CONTAINERS

(71) Applicant: Endress+Hauser SE+Co. KG, Maulburg (DE)

(72) Inventors: Björn Bellmann, Freiburg (DE); Daniel Hoy, Hombourg (FR)

(21) Appl. No.: 19/381,770

(22) Filed: Nov. 6, 2025

(30) Foreign Application Priority Data
Nov. 19, 2024 (DE) 10 2024 133 900.4

(51) Int. Cl. G01F 22/00

(52) U.S. Cl. CPC G01F 22/00

(57) ABSTRACT

A method, and a corresponding measuring system, for highly accurate determining of a temperature-normalized fill volume of a fill substance in a container includes measuring the fill level of the fill substance, averaging fill substance temperatures, and determining the fill volume using the measured fill level and a linearization model for the particular container. The normalization of the fill volume to a defined standard temperature occurs based on the ascertained fill volume, the averaged fill substance temperature, and the temperature dependent expansion coefficient of the fill substance. The averaged fill substance temperature is calculated based on a plurality of temperature values measured in the container interior in mutually adjoining height segments.

### CROSS-REFERENCE TO RELATED APPLICATION

The present application is related to and claims the priority benefit of German patent application no. DE 10 2024 133 900.4, filed on Nov. 19, 2024, the entire contents of which are incorporated herein by reference.

### TECHNICAL FIELD

The invention relates to temperature-normalized fill volume determination in containers based on fill level measurement.

### BACKGROUND

In process automation technology, field devices are applied for registering relevant process parameters. Suitable measuring principles are implemented for this. Examples of process parameters include fill level, flow, pressure, temperature, pH value, redox potential, media-density and conductivity. The most varied of such field device types are manufactured and sold by the Endress+Hauser group of firms.

Widely accepted for fill level measurement of media in containers are travel time based measurement methods. Applied for signal travel time measurement can be, on the one hand, probe based measuring methods, which use, for example, the TDR-based measuring principle (“Time Domain Reflectometry”). On the other hand, also ultrasonic and radar based measuring methods can be used, which operate based, for example, on the pulse travel time principle or the FMCW principle (“Frequency Modulated Continuous Wave”) and involve corresponding high frequency signals radiated via a suitable antenna. The FMCW based fill level measuring method is described, for example, in disclosure document DE 10 2013 108 490 A1. In some fill level measuring device types, moreover, the plumb bob principle is used, in the case of which a fill substance float element is let down by a cable to the fill substance, such that the fill level comes from the lowered cable length.

Starting from the measured fill level, it is often of actual interest to determine the fill volume currently used by the fill substance in the container. A possibility for this is a linearization model, also known as a linearizing table, tank table or linearization curve. This is the relationship between fill level value and fill volume, which the fill substance currently uses in the particular container. In such case, the linearization model is independent of the type of fill substance present in the container. The linearization model can be in the form of an analytical function or a numerical table. The creation of a linearization model is described, for example, in the publication WO 2020/216462.

Depending on field of application, it is, moreover, necessary to normalize the fill volume to a defined standard temperature, since, for example, in the case of fuels, different fuel types expand differently as a function of temperature. Therefore, in the case of fill volume determination in these cases
fill level and fill substance temperature are measured,
the fill volume is determined by means of the measured fill level value and the linearization model for the container, and
the fill volume is normalized to a defined standard temperature by means of
   the ascertained fill volume,
   the ascertained fill substance temperature, and
   a temperature dependent expansion function of the fill substance type.

In such case, use is made of the fact that the expansion function, in linear cases, the coefficient of thermal expansion, is already very exactly determined in the case of established fill substance types. Especially in the case of large container volume, however, the temperature can, depending on height, vary greatly within the container, whereby a temperature normalization of the ascertained fill volume becomes difficult. An object of the invention, therefore, is to be able to normalize the ascertained fill volume more exactly with reference to temperature.

### SUMMARY

The object is achieved according to the invention in that an averaged fill substance temperature is calculated based on at least two temperature values, wherein the temperature values are measured in the container interior in adjoining height segments. This enables weighting the temperature values measured in the separate height segments for determining the averaged fill substance temperature in such a manner that the weighting factors of the temperature values correspond to the volume fractions of the height segments relative to the total volume of the container.

In principle, it is not decisive within the scope of the invention, whether the individual height segments are so defined that they have the same height expansion, or not, as long as the temperature values with respect to container height are measured centrally in the height segments. Conversely, this means that the position and the expansion of each individual height segment is defined by the individual positions of the temperature sensors relative to container height. By the weighting of the temperature values, it is, thus, assumed by way of approximation that the temperature in each height segment is about constant. In order that each of the height segments has the same height, the temperature measuring device is, in turn, to be designed in such a manner that the individual temperature sensors, by means of which the temperature values are registered in the height segments, are, with respect to container height, in each case, arranged equally spaced from one another. It is, however, not required within the scope of the invention that the temperature sensors be arranged equally spaced relative to one another, or that each of the height segments has the same height. The method of the invention can be further optimized by not taking into consideration for calculating the average fill substance temperature the temperature values of the height segments, which are momentarily located completely above the fill level.

A measuring system suitable for performing the method of the invention according to one of the above described embodiments comprises:
a fill level measuring device, which is arranged at the container and based, for example, on the radar-, ultrasound, float- or TDR principle for determining fill level of the fill substance,
a temperature measuring device having a number of temperature sensors corresponding to the height segments, in order to determine a temperature value of the fill substance in each of the mutually adjoining height segments, and
a superordinated unit designed
   to calculate fill volume based on the measured fill level as well as based on the linearization model,
   to calculate average fill substance temperature by means of the measured temperature values, and
   to normalize the fill volume to a defined temperature standard based on the averaged fill substance temperature and the expansion function.

In such case, the superordinated unit can with corresponding design determine the weighting factors for the temperature values of the height segments based, for example, on the linearization model, since the volume fraction of the height segments relative to the total volume in the container interior is derivable therefrom.

The form of the superordinated unit is not decisive in the scope of the invention: functioning as superordinated unit can be, for example, a process control station, a decentral server or a portable calculating device. Likewise, the superordinated unit can be designed as an integral component of the fill level measuring device and/or the temperature measuring device.

### BRIEF DESCRIPTION OF THE DRAWINGS

The invention will now be explained in greater detail based on the appended drawing, the sole FIGURE of which shows as follows:

FIG. 1 shows a measuring system of the invention mounted on a container.

### DETAILED DESCRIPTION

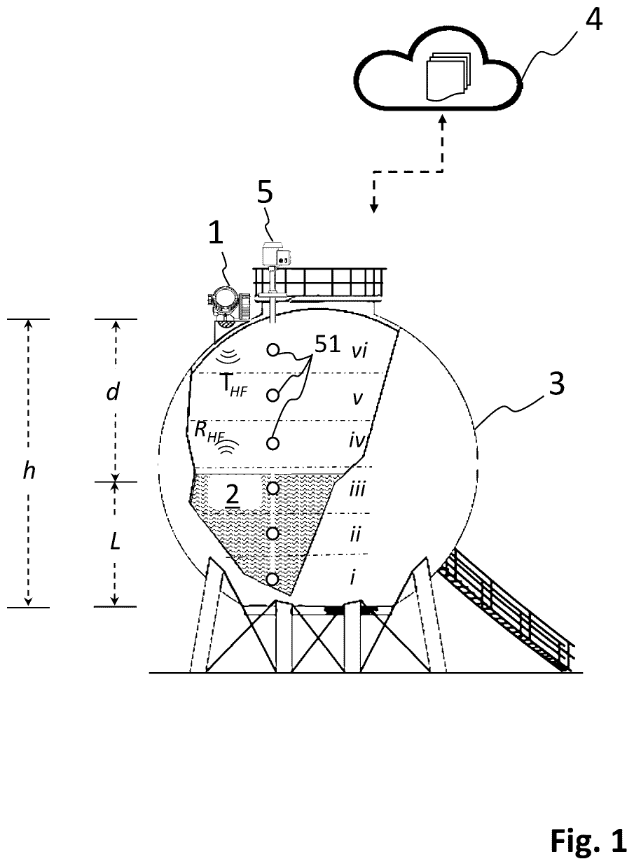

FIG. 1 shows a container 3, in which is located a liquid fill substance 2, such as a fuel, for example. In such case, it is important, for example, for logistical reasons, to register, as exactly and temperature compensated as possible, the fill volume, which the fill substance 2 currently occupies in the container 3. For this in the illustrated embodiment, a freely radiating radar fill level measuring device 1 is installed at a known height h above the container floor. Fill level measuring device 1 is so oriented that, as a function of the implemented radar principle, corresponding transmitted radar signals T_{HF} are transmitted approximately vertically downwards in the direction of the fill substance 2.

After reflection of the radar signal T_{HF} on the fill substance surface, the fill level measuring device 1 receives the radar signals R_{HF} reflected on the fill substance surface after a defined signal travel time, wherein the signal travel time depends on the distance d of the fill level measuring device 1 from the reflection point on the fill substance surface. Since the fill level measuring device 1 can measure the signal travel time based on the reflected radar signal R_{HF} and associate the corresponding distance d, the fill level measuring device 1 can ascertain the fill level value L at the point of the fill substance surface using the formula

$$L = h - d$$

provided that the installed height h of the fill level measuring device 1 above the container floor in the fill level measuring device 1 is furnished. In contrast with the embodiment shown in FIG. 1, it is within the scope of the invention also possible to use, instead of the measuring method of this embodiment, any other measuring method, by means of which the fill level L is determinable.

As a rule, the fill level measuring device 1 is connected via a suitable interface, such as, for instance, PROFIBUS, HART, WirelessHART, 4-20 mA, Bluetooth, Sakura V1, GSM, WM550, or Ethernet, to a superordinated unit 4, such as e.g. a process control system or a decentral server, whereby a corresponding measuring system is formed. The embodiment of the superordinated unit 4 shown in FIG. 1 is implemented in the form of a decentral server. Via the interface to the superordinated unit 4, the fill level value L, or the distance d or the underpinning measurement data can be transferred. For the case, in which only the distance d or the underpinning measurement data is transferred, the calculating of the fill level L based thereon can occur in the superordinated unit 4, when it has been furnished the installed height h of the fill level measuring device 1 above the container floor.

In general within the scope of the invention, the terminology unit means, in principle, any electronic circuit or hardware suitable for the intended application. It can, thus, depending on requirements, be an analog circuit for producing, or processing, corresponding analog signals. It can, however, also be a digital circuit, such as an FPGA, or a storage medium in cooperation with a program. In such case, the program is designed to perform the corresponding method steps, or to apply the required computer operations of the particular unit. In this context, an electronic unit can also be composed of a number of networked memory/computing units.

In the state of the art, it is possible by means of a method, such as the ultrasonic, FMCW-, TDR-based- or the pulse travel time method, to resolve the fill level L pointwise with an accuracy in the sub-micrometer range. In order based on the measured fill level value L to be able to determine the fill volume used by the fill substance 2 instantaneously in the interior of the container 3, a corresponding linearization model is created for the particular container 3. The linearization model describes the relationship between the measured fill level L and the corresponding fill volume in the container, wherein the linearization model can, in turn, be stored in the fill level measuring device 1, or in the superordinated unit 4. Depending on where the linearization model is stored, the fill volume calculation can occur based on the currently ascertained fill level value L directly in the fill level measuring device 1 or in the superordinated unit 4. The linearization model can be ascertained, for example, from the construction documents, or the CAD files for the container 3. Examples of methods for generating the linearization model include: “ray tracing”, the “discrete element method (DEM)” and the “Lagrangian particle model (LPM)”.

Since, especially in the case of highly accurate applications, the fill volume is to be ascertained temperature compensated, the measuring system includes additionally a temperature measuring device 5. Analogously to the fill level measuring device 1, also the temperature measuring device 5 is connected with the superordinated unit 4, in order to be able to determine or transmit an averaged fill substance temperature T_{M}. Based on the averaged fill substance temperature T_{M}, the calculated value of the fill volume can be normalized within the superordinated unit 4 to a defined standard temperature, for example, 298.15 Kelvin. This increases the comparability of the ascertained fill volume. For normalization of the fill volume, it is required that the fill substance type be known, to the extent that the coefficient of thermal expansion—or, in the non-linear case, the corresponding expansion function—of the fill substance type can be furnished in the superordinated unit 4.

In the case of the example of an embodiment of the measuring system of the invention shown in FIG. 1, the temperature measuring device 5 includes six temperature sensors 51i-vi for ascertaining the averaged fill substance temperature T_{M}. In such case, the temperature sensors 51i-vi are arranged distributed at different heights in the container interior with equal separations from one another with reference to container height h, in order to measure six temperature values Tᵢ₋ᵥᵢ. For this, the temperature sensors 51i-vi are integrated into a rod shaped arrangement in the embodiment shown in FIG. 1. As can be seen from FIG. 1, the rod shaped arrangement extends for this vertically downwards into the container interior from an electronics housing of temperature measuring device 5, which serves for signal evaluation and is mounted at an opening on the upper side of the container 3. The averaged fill substance temperature T_{M} is calculated based on the individually measured temperature values Tᵢ₋ᵥᵢ

By the vertical arrangement of the temperature sensors 51i-vi, which in the illustrated example of an embodiment are equally distributed, a number of height segments i-vi are defined within the container 3 corresponding to the number of temperature sensors 51i-vi. As evident from FIG. 1, each of the temperature sensors 51i-vi is located with respect to container height h centrally in its height segment i-vi. In this way, and by the vertical, uniform distribution of the temperature sensors 51i-vi, the height segments i-vi have correspondingly, in each case, the same height expansion, which is constant in the horizontal direction over the container interior, again, in each height segment i-vi. When in contrast to the shown embodiment, the temperature sensors are not arranged equally distributed, the lateral expansion of the height segments i-vi can be defined in such a manner that the height segments i-vi, vertically considered, adjoin one another in each case, centrally between two temperature sensors i-vi, in which case the individual temperature sensors i-vi are not located centrally in their corresponding height segments i-vi.

According to the invention, the superordinated unit 4 can, based on the known, vertical separations of the individual temperature sensors 51i-vi relative to one another, or their known, vertical positions in the container 3, calculate from the linearization model for each height segment i-vi its volume fraction % Vᵢ₋ᵥᵢ relative to the total volume Vₜₒₜ within the container 2. The superordinated unit 4 can, in turn, set the so ascertained volume fractions % Vᵢ₋ᵥᵢ equal to the weighting factors nᵢ₋ᵥᵢ for the corresponding height segments i-vi, or for corresponding temperature sensors 51i-vi. Accordingly, the temperature values Tᵢ₋ᵥᵢ ascertained by the temperature sensors 51i-vi enter the averaged fill substance temperature T_{M} with such weighting factors nᵢ₋ᵥᵢ according to

$${T}_{M} = {\sum }_{i}^{v i} ( {n}_{i - v i} ) * {T}_{i - v i} .$$

Since the fill level measuring device 1 sends the superordinated unit 4 the current fill level value L, the superordinated unit 4 can based on such information and based on the known, vertical positions and the temperature sensors 51i-vi, moreover, ascertain according to the invention which of the temperature sensors 51i-vi is/are currently located above the fill substance 2. Accordingly, the superordinated unit 4 can ignore their temperature values T_{iv,v,vi} in the calculating of the averaged fill substance temperature T_{M}. Such makes sense especially when the atmosphere in the container 3 above the fill substance 2 differs greatly from the fill substance temperature, for example, due to climatic fluctuations. In this way, the temperature-normalization of the fill volume becomes yet more accurate.

In the case of the example of an embodiment shown in FIG. 1, the height segment iii is not completely filled by fill substance 2, while the corresponding temperature sensor iii is covered by the fill substance 2. Also this constellation can be detected by the superordinated unit 4 based on the ascertained fill level value L and taken into consideration as regards the averaged fill substance temperature T_{M}, since the superordinated unit 4 knows the position of the corresponding height segment iii: When such a constellation occurs in one of the height segments i-vi, the superordinated unit 4 can based on the linearization model calculate, in turn, what percent of the affected height segment iii is filled and adapt the corresponding weighting factor nᵢ₋ᵥᵢ by such percentage. A yet more exact temperature normalization can only be achieved by increasing the number of temperature sensors 5i-vi. Thus, it is clear that the method of the invention requires for temperature value averaging at least two temperature sensors 5i-vi arranged in adjoining height segments i-vi.

In contrast with the example of an embodiment shown in FIG. 1, in the case of which the container 3 has a spherically shaped geometry, the method of the invention is naturally also usable for any other container shape, as long as the underpinning linearization model is ascertainable.

1. A method for determining a temperature-normalized fill volume of a fill substance in a container, the method comprising:
measuring a fill level of the fill substance in the container;
calculating an averaged fill substance temperature;
determining a fill volume using the measured fill level and a linearization model for the container; and
normalizing the fill volume to a defined standard temperature based on the determined fill volume, the averaged fill substance temperature, and a temperature dependent expansion function of the fill substance in the container,
wherein the averaged fill substance temperature is calculated based on at least two temperature values measured in the container interior in adjoining height segments.

2. The method as claimed in claim 1, wherein the height segments have a same height expansion, and wherein the temperature values are measured with respect to container height centrally in the height segments.

3. The method as claimed in claim 1, wherein temperature values of height segments momentarily located completely above the fill level are not taken into consideration for calculating the average fill substance temperature.

4. The method as claimed in claim 1, wherein the at least two temperature values measured in the individual height segments enter weighted in the averaged fill substance temperature such that the weighting factors of the at least two temperature values correspond to the volume fractions of the height segments relative to the total volume of the container.

5. A measuring system for determining a temperature-normalized fill volume of a fill substance in a container, the measuring system comprising:
a fill level measuring device that is arranged at the container for determining a fill level of the fill substance;
a temperature measuring means, including:
a plurality of temperature sensors corresponding to height segments to determine a temperature value of the fill substance in each of mutually adjoining height segments;
a superordinated unit configured to calculate a fill volume based on the measured fill level as well as based on a linearization model, to calculate an average fill substance temperature using the measured temperature values, and to normalize the fill volume to a defined standard temperature based on the averaged fill substance temperature and the expansion function.

6. The measuring system as claimed in claim 5, wherein the superordinated unit is further configured to determine weighting factors for the temperature values of the height segments based on the linearization model.

7. The measuring system as claimed in claim 5, wherein a decentral server or a portable calculating device functions as superordinated unit.

8. The measuring system as claimed in claim 5, wherein the superordinated unit is designed as an integral component of the fill level measuring device and/or of temperature measuring means.

9. The measuring system as claimed in claim 5, wherein the temperature measuring means is designed in such a manner that the temperature sensors are arranged with respect to container height equally spaced from one another, in order to register the temperature values in the individual height segments.

10. The measuring system as claimed in one of claim 5, wherein the fill level measuring device is based on the radar-, ultrasound, float- or TDR principle.
